(19) United States
(12) Patent Application Publication
(10) Pub. No.: US 2026/0211492 A1
(43) Pub. Date: Jul. 23, 2026

(54) CONFIGURING MULTIPLE EXTERNAL DISPLAYS FOR A MOBILE DEVICE

(71) Applicant: International Business Machines Corporation, Armonk, NY (US)

(72) Inventors: Paul Llamas Virgen, Guadalajara (MX); Carlos Andres Martinez Vazquez, Tlaquepaque (MX); Mara Miranda Bautista, Tlajomulco de Zuniga (MX); Silvia Esther Sanchez Lopez, Tlaquepaque (MX)

(73) Assignee: International Business Machines Corporation, Armonk, NY (US)

(21) Appl. No.: 19/035,372

(22) Filed: Jan. 23, 2025

(51) Int. Cl. G06F 3/01; G06F 3/14

(52) U.S. Cl. CPC G06F 3/013; G06F 3/1423

(57) ABSTRACT

A method for automatically configuring multiple external monitors for a user's mobile device is presented. The method takes into account the characteristics and capabilities of the mobile device involved, as well as the user's automatic feedback, in order to ensure that the configuration is optimal for the user. The method analyzes the capabilities, such as resolution, scaling, and orientation, of each external display. The method also takes into account the user's preferences, such as which applications they use most frequently and how they prefer to interact with their desktop.

### TECHNICAL FIELD

The present invention relates to computer displays in general, and in particular, to a method for automatically configuring multiple external displays for a mobile device.

### BACKGROUND

Multiple displays are often employed in a variety of environments such as workplaces (e.g., offices, conference rooms, control rooms, etc.), schools (e.g., classrooms, auditoriums, etc.), and gaming setups. A user may need to connect his/her mobile device, such as a laptop computer, to multiple displays at various locations. Since the display setups are usually different at each location, the user will have to manually configure his/her mobile device for the multiple display setups at different locations. However, manually configuring the order and arrangement of multiple displays can be a challenging task for many users, especially for those who are not familiar with the specific steps involved.

Some of the challenges that a user may face when configuring multiple displays on a mobile device may include resolution, scaling, brightness, orientation, coloring, etc. Each display can have a different resolution or scaling setting, which can affect the overall look and feel of the applications. This can be problematic if a user is working with high-resolution or large-format displays. In addition, the physical placement of each display is an important factor to consider because it can affect how the user interacts with the desktop and other applications. The user may need to adjust the alignment and orientation of each display in order to achieve the desired effect.

Basically, configuring multiple displays can be daunting for many users, and may require a significant amount of time and effort to get it right. The problem becomes even more complex when there is a large number of displays needed to be connected at the same time because there are more factors to consider and more potential issues that can arise.

Consequently, it would be desirable to provide an improved method for automatically adjusting the configuration of multiple displays for a mobile device to enable a customized and efficient multi-display setup for users.

### SUMMARY OF THE INVENTION

In accordance with one embodiment of the present invention, in response to a user connecting multiple displays to a mobile device, the resolutions and capabilities of each of the displays are obtained. After retrieving user information of the user from a user profile within the mobile device, a camera on the mobile device is turned on in order to track the eye movements of the user. The eye movement information is then correlated to the retrieved user information. Next, a new display configuration is presented to the user for the user to consider. If the user decides to accept the new display configuration, then the new display configuration is applied to the mobile device.

### BRIEF DESCRIPTION OF THE DRAWINGS

FIG. 1A is a block diagram of a multi-display configuration in which one embodiment of the present invention can be incorporated;

FIG. 1B is a block diagram of a laptop computer in which one embodiment of the present invention can be incorporated;

FIG. 2 is a flowchart of a method for automatically configuring multiple external displays for a laptop computer, according to one embodiment of the present invention; and

FIG. 3 is a block diagram of a computing environment in which an embodiment of present invention can be incorporated.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

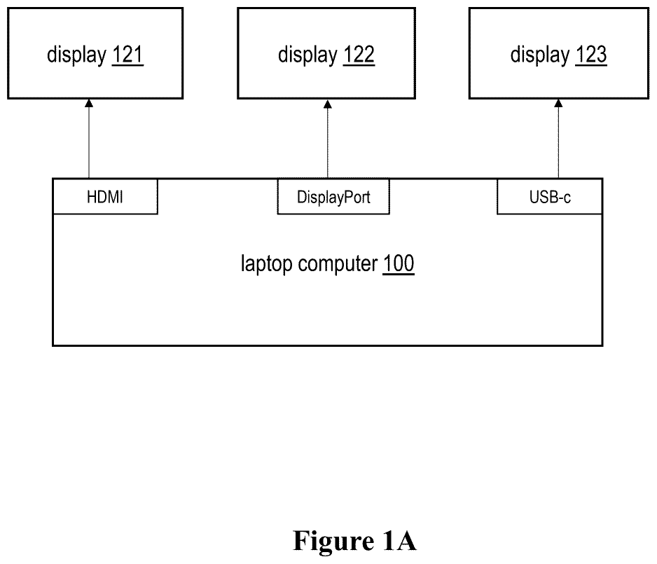

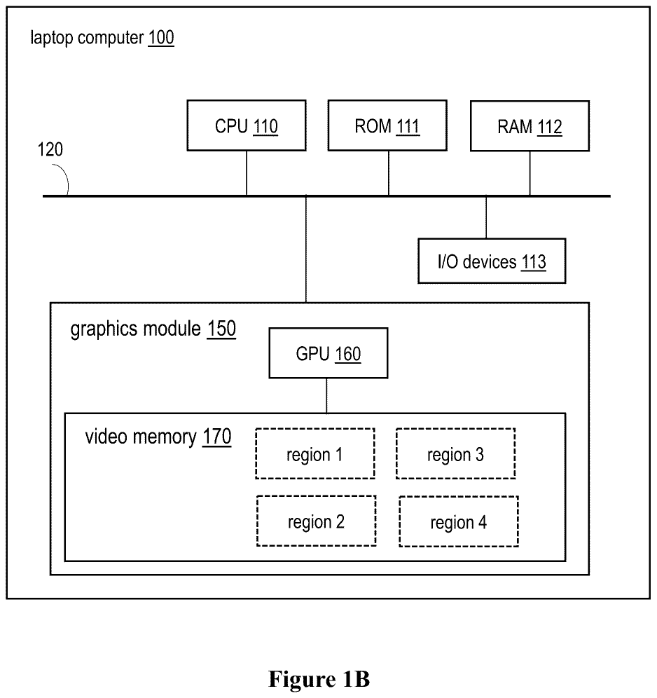

Referring now to the drawings, and in particular to FIG. 1A, there is illustrated a block diagram of a multi-display configuration in which one embodiment of the present invention can be incorporated. As shown, a laptop computer 100 is simultaneously connected to three external displays 121, 122 and 123. Connecting laptop computer 100 to multiple displays 121-123, also known as a multi-display setup, is made possible by using different video output ports available on laptop computer 100 to connect displays 121-123. Although a laptop computer is utilized to illustrate the present embodiment, it is understood by those skilled in the art that the present invention is also applicable to any mobile device having a camera, such as a tablet computer, a smartphone, etc.

For the present embodiment, display 121 is connected to a HDMI port of laptop computer 100, display 122 is connected to a DisplayPort of laptop computer 100, and display 123 is connected to a USB-C port of laptop computer 100. This multi-display setup allows a user to extend laptop computer 100 across multiple screens or duplicate the same screen on one or more of displays 121-123, depending on the preference of the user. Although only three external displays are illustrated in FIG. 1A, it is understood by those skilled in the art that the present invention can be applicable to two or more external displays. In addition, it is understood by those skilled in the art that displays can be connected to laptop computer 100 via ports other than HDMI port, DisplayPort, and USB-C port.

With reference now to FIG. 1B, there is illustrated a block diagram of the components within laptop computer 100 in order to provide the multi-display setup depicted in FIG. 1A, according to one embodiment of the present invention. As shown, laptop computer 100 includes a central processing unit (CPU) 110, a read-only memory (ROM) 111, a random-access memory (RAM) 112, input/output (I/O) devices 113, and a graphics module 150, connected to each other via a bus 120. ROM 111 includes software code for booting up laptop computer 100. RAM 112, which is commonly employed as system memory, provides a location where software code and the associated data can be processed by CPU 110. In addition to various storage devices, I/O devices 17 include a built-in display, a camera, a keyboard, a touch pad, etc.

Graphics module 150 includes a graphics processing unit (GPU) 160 and a video memory 170. In conjunction with CPU 110, GPU 150 handles code and data that are related to graphics processing. Video memory 170 is a specific type of RAMs that are designed to handle graphical data. When multiple displays are connected to laptop computer 100, video memory 170 allocates separate “regions” within the overall video memory pool, with each region dedicated to rendering the image for a specific display, allowing graphics module 150 to update the pixels for each screen independently and simultaneously. In essence, each display gets its own frame buffer within video memory 170. For example, since laptop computer 100 is connected to three external displays 121-123, as shown in FIG. 1A, four regions are allocated within video memory 170. Specifically, region 1 is associated with the built-in display of laptop computer 100, region 2 is associated with display 121, region 3 is associated with display 122, and region 4 is associated with display 123.

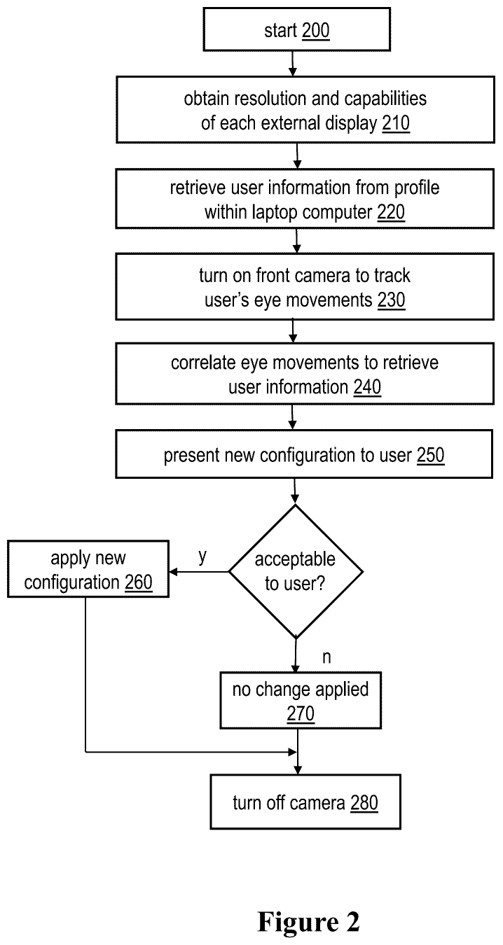

With reference now to FIG. 2, there is illustrated a flowchart of a method for automatically configuring multiple external displays for a laptop computer, according to one embodiment of the present invention. Starting at block 200, after a user has connected multiple external displays (such as displays 121-123 in FIG. 1A) to a laptop computer (such as laptop computer 100 in FIG. 1A), the resolutions and other capabilities of each of the external displays are obtained, as shown in block 210. The external displays can be connected to the laptop computer via cables or wirelessly. After the resolution and other capabilities of each display have been obtained, that information is then saved under a display profile within the laptop computer. The profile of any new external display can be updated, if necessary, within the laptop computer. The video control (such as GPU 160) of the laptop computer provides an optimal setting for each of the external displays according to the resolution and capabilities of each of the external displays.

At the same time, the user information is retrieved from the user profile within the laptop computer, as depicted in block 220.

Next, a front camera on the laptop computer is turned on in order to track the eye movements of a user, as shown in block 230. The front camera detects and tracks the user's eye movements, and determines which display the user is looking at and/or which location on the display the user is looking at.

The user's eye movement information is correlated with the retrieved user information, as depicted in block 240. The eye-tracking information is correlated with the user's usual interaction, such as mouse movements, keyboard inputs, and software window placement on the display. Specifically, the front camera detects for a mismatch between the user's eye movement and mouse movement. For example, the user may be looking at an external display located on the right side of the user while the user is entering data to an external display that is supposed to be located on the left side of the user.

A new suggested configuration for the external display arrangement is presented to the user, as shown in block 250. Based on the information gathered in block 240, the best position, order, and resolution for the external display configuration are suggested for the user's consideration. For example, if the user is trying to focus on a specific portion of a display in which text is displayed, the eye-tracking method can locate the section the user is looking at, and determines whether or not the text is too small, and proposes to the user for a resolution adjustment.

The user is then prompted to accept the suggested display configuration. If the user accepts the suggested configuration, the suggested configuration is applied and stored in the user profile, as depicted in block 260, and the camera can be turned off, as depicted in block 280. After the user has accepted the suggested display configuration, the suggested display configuration is then automatically applied to the display setup. For example, the regions within video memory 211 from FIG. 1B can be swapped in order to realign the video information to appropriate displays 121-123 for the user.

However, if the user does not accept the suggested configuration, the suggested changes will not be applied and can be discarded, as shown in block 270, and the camera can be turned off, as depicted in block 280.

As has been described, the present invention provides a method for automatically configuring multiple displays for a laptop computer without the need of a user to have prior knowledge of configuring displays. By taking into account the displays'characteristics and the user's preferences and active non-interactive feedback, the method is able to generate an optimal configuration that maximizes productivity and efficiency for the user.

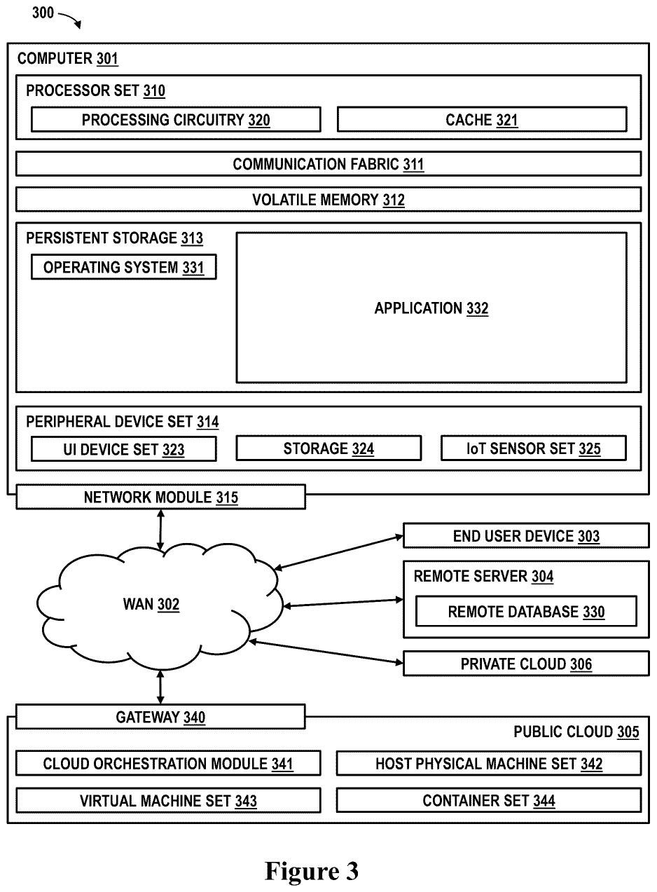

Referring now to FIG. 3, there is illustrated a block diagram of a computing environment in which an embodiment of present invention can be executed. As shown, a computing environment 300 contains an example of an environment for the execution of at least some of the computer code involved in performing the inventive methods, such as a method for automatically configuring multiple external displays for a mobile device via one of application code 323. Computing environment 300 also includes, for example, computer 301, wide-area network (WAN) 302, end user device (EUD) 303, remote server 304, public cloud 305, and private cloud 306. In this embodiment, computer 301 includes a processor set 310 having processing circuitry 320 and cache 321, communication fabric 311, volatile memory 312, persistent storage 313 (including operating system 322 and applications 323), a peripheral device set 314 (including user interface device set 323, and an Internet of Things (IoT) sensor set 325), and a network module 315. Public cloud 305 includes a gateway 340, a cloud orchestration module 341, physical machines 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud. On the other hand, computer 301 is not required to be in a cloud except to any extent as may be affirmatively indicated.

Processors 310 includes one or more processing elements, such as processing elements 122-125 in FIG. 1, of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processors 310. Cache memories are typically organized into multiple levels depending upon relative proximity to the processing circuitry. Alternatively, some, or all, of the cache for the processor set may be located off chip. In some computing environments, processors 310 may be designed for working with qubits and performing quantum computing.

Communication fabric 311 is the signal conduction paths that allow the various components of computer 301 to communicate with each other. This fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random-access memory (RAM) or static type RAM. Volatile memory 312 is characterized by random access, but this is not required unless affirmatively indicated. In computer 301, volatile memory 312 is located in a single package and is internal to computer 301, but, alternatively or additionally, volatile memory 312 may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read-only memory (ROM), but typically at least a portion of the persistent storage allows writing of data, deletion of data and re-writing of data. Some familiar forms of persistent storage include magnetic disks and solid state storage devices.

Computer readable program instructions can be stored in persistent storage 313. Computer readable program instructions can cause a series of operational steps to be performed by processors 310 and thereby effect a computer-implemented method, such that the instructions thus executed will instantiate the methods specified in flowcharts and/or narrative descriptions of computer-implemented methods included in this document (collectively referred to as the inventive methods). The program instructions, and associated data, are accessed by processors 310 to control and direct performance of the inventive methods. In computing environment 300, at least some of the instructions for performing the inventive methods, such as the exemplary code depicted in FIG. 2C, may be stored as applications 332 within persistent storage 313.

Persistent storage 313 also includes operating system 331. Operating system 331 may take several forms, such as various known proprietary operating systems or open source Portable Operating System Interface type operating systems that employ a kernel.

Peripheral devices 313 include the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) devices 323 may include components such as a display screen, speaker, microphone, wearable devices (such as goggles and smart watches), keyboard, mouse, printer, touchpad, game controllers, and haptic devices. External storage 324 can be an external hard drive, or insertable storage, such as an SD card. External storage 324 may be persistent and/or volatile. In some embodiments, external storage 324 may take the form of a quantum computing storage device for storing data in the form of qubits. In embodiments where computer 301 is required to have a large amount of storage (for example, where computer 301 locally stores and manages a large database), then this storage may be provided by peripheral storage devices designed for storing very large amounts of data, such as a storage area network (SAN) that is shared by multiple, geographically distributed computers. IoT sensors 325 are made up of sensors that can be used in Internet-of-Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or WiFi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can be downloaded to computer 301 from an external computer or external storage device through a network adapter card or network interface included within network module 315.

WAN 302 is any wide-area network (for example, the internet) capable of communicating computer data over non-local distances by any technology for communicating computer data, now known or to be developed in the future. In some embodiments, WAN 302 may be replaced and/or supplemented by local-area networks (LANs) designed to communicate data between devices located in a local area, such as a WiFi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 115 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from a remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machines 342, which is the universe of physical computers in and/or available to public cloud 305. Virtual computing environments (VCEs) typically take the form of virtual machines from virtual machines 343 and/or containers from containers 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is a collection of computer software, hardware, and firmware that allows public cloud 305 to communicate through WAN 302.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 305 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the invention has been particularly shown and described with reference to a preferred embodiment, it will be understood by those skilled in the art that various changes in form and detail may be made therein without departing from the spirit and scope of the invention.

1. A computer-implemented method, comprising:
obtaining resolutions and capabilities of each display of a plurality of external displays based on a user connecting said plurality of external displays to a mobile device;
retrieving user information of said user from a user profile within said mobile device;
turning on a camera on said mobile device to track eye movements of said user;
retrieving, based on said tracked eye movements, eye movement information of said user;
correlating said retrieved eye movement information to said retrieved user information;
presenting, based on said correlation, a new display configuration for said user to consider, wherein said new display configuration is associated with a set of external displays of said plurality of external displays; and
applying said presented new display configuration to said mobile device in a case where said user accepts said presented new display configuration.

2. The computer-implemented method of claim 1, wherein said mobile device is selected from a group consisting of a laptop, a computer and a smartphone.

3. The computer-implemented method of claim 1, wherein said correlating further includes tracking said eye movement information and correlating said eye movement information with said retrieved user information.

4. The computer-implemented method of claim 1, wherein said applying further includes swapping regions within a video memory of said mobile device to realign video information to appropriate ones of said plurality of external displays for said user.

5. The computer-implemented method of claim 1, method further comprising storing said obtained resolutions and capabilities of said plurality of external displays in a display profile within said mobile device.

6. The computer-implemented method of claim 5, further comprising providing an optimal setting for each display of said plurality of external displays according to said obtained resolutions and capabilities.

7. The computer-implemented method of claim 1, further comprising discarding said presented new display configuration in a case where said user does not accept said presented new display configuration.

8. A computer program product for automatically configuring a plurality of multiple external displays for a mobile device, said computer program product comprising a computer readable storage medium having program instructions embodied therein, said program instructions executable by a computer to cause said computer to perform operations comprising:
obtaining resolutions and capabilities of each display of said plurality of external displays based on a user connecting said plurality of external displays to the mobile device;
retrieving user information of said user from a user profile within said mobile device;
turning on a camera on said mobile device to track eye movements of said user;
retrieving, based on said tracked eye movements, eye movement information of said user;
correlating said retrieved eye movement information to said retrieved user information;
presenting, based on said correlation, a new display configuration for said user to consider, wherein said new display configuration is associated with a set of external displays of said plurality of external displays; and
applying said presented new display configuration to said mobile device in a case where said user accepts said presented new display configuration.

9. The computer program product of claim 8, wherein said mobile device is selected from a group consisting of a laptop, a computer, and a smartphone.

10. The computer program product of claim 8, wherein said correlating further includes tracking said eye movement information and correlating said eye movement information with said retrieved user information.

11. The computer program product of claim 8, wherein said applying further includes swapping regions within a video memory of said mobile device to realign video information to appropriate ones of said plurality of external displays for said user.

12. The computer program product of claim 8, wherein said program instructions further include storing said obtained resolutions and capabilities of said plurality of external displays in a display profile within said mobile device.

13. The computer program product of claim 12, wherein said program instructions further include providing an optimal setting for each display of said plurality of external displays according to said obtained resolutions and capabilities.

14. The computer program product of claim 8, wherein said program instructions further include discarding said presented new display configuration in a case where said user does not accept said presented new display configuration.

15. A computer system, comprising:
a processor set;
one or more computer-readable storage media; and
program instructions stored on the one or more computer-readable storage media to cause said processor set to perform operations comprising:
obtaining resolutions and capabilities of each display of a plurality of external displays based on a user connecting said plurality of external displays to a mobile device;
retrieving user information of said user from a user profile within said mobile device;
turning on a camera on said mobile device to track eye movements of said user;
retrieving, based on said tracked eye movements, eye movement information of said user;
correlating said retrieved eye movement information to said retrieved user information;
presenting, based on said correlation, a new display configuration for said user to consider, wherein said new display configuration is associated with a set of external displays of said plurality of external displays; and
applying said presented new display configuration to said mobile device in a case where said user accepts said presented new display configuration.

16. The computer system of claim 15, wherein said mobile device is selected from a group consisting of a laptop, a computer, and a smartphone.

17. The computer system of claim 15, wherein said correlating further includes tracking said eye movement information and correlating said eye movement information with said retrieved user information.

18. The computer system of claim 15, wherein said applying further includes swapping regions within a video memory of said mobile device to realign video information to appropriate ones of said plurality of external displays for said user.

19. The computer system of claim 15, wherein said operations further include storing said obtained resolutions and capabilities of said plurality of external displays in a display profile within said mobile device.

20. The computer system of claim 19, wherein said operations further include providing an optimal setting for each display of said plurality of external displays according to said obtained resolutions and capabilities.
